(19) United States
(12) Patent Application Publication
(10) Pub. No.: US 2007/0029472 A1
(43) Pub. Date: Feb. 8, 2007

(54) Light emitting and receiving integrated device and optical disk apparatus

(76) Inventor: Kiyoshi Yamauchi, Kanagawa (JP)

Correspondence Address: ROBERT J. DEPKE;LEWIS T. STEADMAN, ROCKEY, DEPKE, LYONS AND KITZINGER, LLC, SUITE 5450 SEARS TOWER, CHICAGO, IL, 60606-6306, US

(21) Appl. No.: 11/438,377

(22) Filed: May 22, 2006

(30) Foreign Application Priority Data
Jun. 2, 2005 (JP) JP 2005-162328

(51) Int. Cl. H01J 5/02

(52) U.S. Cl. 250/239

(57) ABSTRACT

A light emitting and receiving integrated device is disclosed wherein a light emitting element can be sealed with a sufficiently high degree of air-tightness. The light emitting and receiving integrated device includes a package body, a light emitting element mounted on a first face side of the package body, and a light receiving element mounted on a second face side of the package body remote from the first face. A sealing member seals only the light emitting element on the first face side of the package body.

### CROSS REFERENCES TO RELATED APPLICATIONS

The present invention contains subject matter related to Japanese Patent Application JP 2005-162328 filed in the Japanese Patent Office on Jun. 2, 2005, the entire contents of which being incorporated herein by reference.

### BACKGROUND OF THE INVENTION

1. Field of the Invention

This invention relates to a light emitting and receiving integrated device suitable for use with an optical pickup and an optical disk apparatus which includes a light emitting and receiving integrated device.

2. Description of Related Art

An optical disk apparatus which records and reproduces data on and from an optical disk used as a recording medium such as a CD (Compact Disk), a DVD (Digital Versatile Disk) or a PD (Phase change Disk) incorporates an optical pickup as a principal component for recording and reproduction. The optical pickup uses a light emitting and receiving integrated device which includes a light emitting element and a light receiving element as disclosed, for example, in Japanese Patent Laid-Open No. 2000-228022.

FIGS. 2A and 2B show a configuration of a conventional light emitting and receiving integrated device. Particularly, FIG. 2A is a sectional view of the light emitting and receiving integrated device, and FIG. 2B is a perspective view, partly broken, of the light emitting and receiving integrated device. Referring to FIGS. 2A and 2B, an element mount portion 52 is formed on an upper face of a package body 51 which serves as a base. A light emitting element 53 is mounted on one side face of the element mount portion 52. Meanwhile, a light receiving element 54 is mounted on an upper face of the element mount portion 52. The light emitting element 53 and the light receiving element 54 are sealed by a cap 55 on the package body 51. The cap 55 is attached to the upper face of the package body 51 in such a state that it surrounds the element mount portion 52. An opening 56 is formed in a ceiling portion of the cap 55. Further, an optical part 57 is mounted on an upper face of the cap 55 in such a form that it closes up the opening 56.

In the light emitting and receiving integrated device having the configuration described above, light emitted from the light emitting element 53 emerges through the opening 56 of the cap 55 and the optical part 57. Thereupon, the light emitted from the light emitting element 53 is split into three beams by a grating portion not shown formed on an upper face of the optical part 57. Further, returning light of the light emerging as described above is received by the light receiving element 54 through the optical part 57 and the opening 56 of the cap 55. Thereupon, the returning light is polarized by a hologram portion not shown formed on a lower face of the optical part 57 and then received by a light receiving face of the light receiving element 54.

### SUMMARY OF THE INVENTION

Generally, in a light emitting and receiving integrated device for an optical pickup, since a semiconductor laser is used for the light emitting element 53, it is necessary to seal the surroundings of the light emitting element 53 in a high air-tight condition. However, in the conventional light emitting and receiving integrated device, since it is structured such that the light emitting element 53 and the light receiving element 54 mounted on the element mount portion 52 are sealed collectively by the cap 55, it is necessary to assure a large region for the sealing region (internal space) of the cap 55 in such a manner as to surround the light emitting element 53 and the light receiving element 54. Therefore, a large bonding area is necessary between the package body 51 and the cap 55, and this makes it difficult to achieve a high degree of air-tightness.

In an embodiment of the present invention, it is desirable to provide a light emitting and receiving integrated device wherein a light emitting element can be sealed with a sufficiently high degree of air-tightness.

In order to attain the desire described above, according to the present invention, there is provided a light emitting and receiving integrated device having a package body, a light emitting element mounted on a first face side of the package body, a light receiving element mounted on a second face side of the package body remote from the first face, and a sealing member for sealing the light emitting element on the first face side of the package body.

In the light emitting and receiving integrated device, the light emitting element is mounted on the first face side of the package body, and the light receiving element is mounted on the second face side of the package body remote from the first face. Thus, only the light emitting element is sealed on the first face side of the package body with the sealing member. Consequently, the sealing region by the sealing member can be reduced when compared with that of the conventional device.

With the light emitting and receiving integrated device, since the light emitting element and the light receiving element are mounted separately on the first face side and the second face side of the package body, respectively, the sealing region by the sealing member can be reduced when compared with that of the conventional device. Consequently, the light emitting element can be sealed with a higher degree of air-tightness.

The above and other features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a sectional view showing a configuration of a light emitting and receiving integrated device to which an embodiment of the present invention is applied; and

FIGS. 2A and 2B are a sectional view and a perspective view, partly broken, respectively, of a conventional light emitting and receiving integrated device.

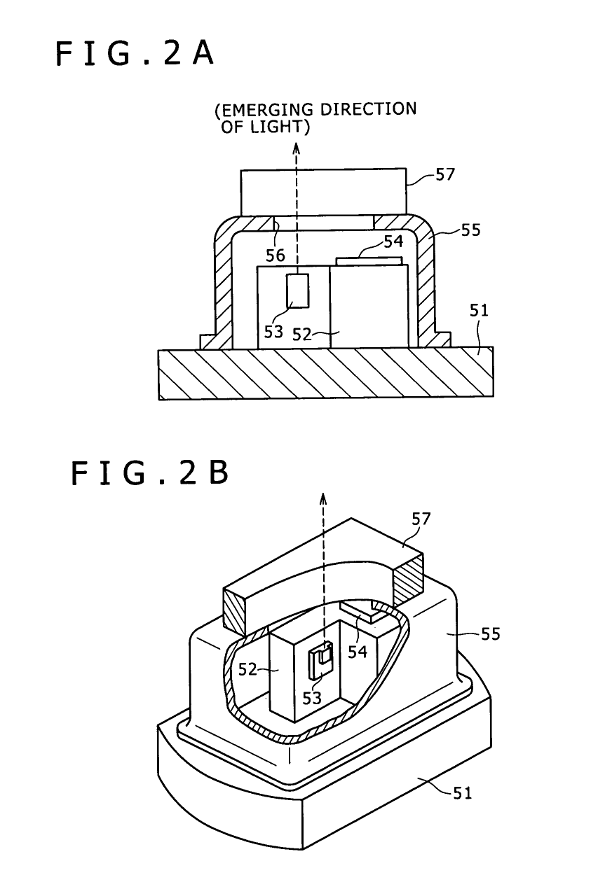

### DETAILED DESCRIPTION OF THE PREFERRED EMBODIMENTS

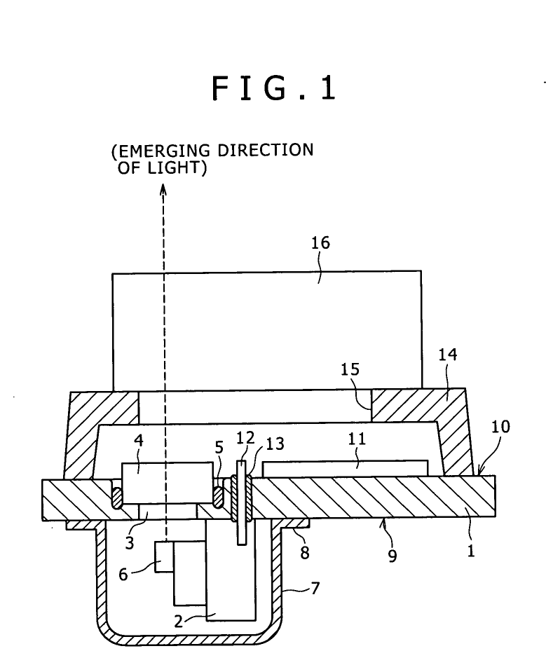

Referring to FIG. 1, there is shown a configuration of a light emitting and receiving integrated device to which an embodiment of the present invention is applied. The package body 1 shown is made of a metal material such as, for example, copper or covar and is generally in the form of a plate. An element mount portion 2 is formed integrally with or as a separate member from the package body 1. Where the element mount portion 2 is formed as a separate member from the package body 1, it is formed as a block using a metal material having a high thermal conductivity such as, for example, copper, aluminum or aluminum nitride. The element mount portion 2 is provided in such a state that it projects in a thicknesswise direction of the package body 1.

Further, the package body 1 has a light transmission portion 3 formed therein. The light transmission portion 3 is provided in the proximity of the element mount portion 2 in such a state that it extends through the package body 1 in the thicknesswise direction. Further, a stepped portion of a channel shape in section is formed coaxially with the light transmission portion 3 on the package body 1, and a lid 4 is attached to the stepped portion. The lid 4 is made of, for example, a glass material in the form of a transparent plate and is fitted in the stepped portion of the package body 1 in such a state that it fully closes up the light transmission portion 3. Further, the lid 4 is securely bonded at an outer peripheral portion thereof to the package body 1 using low-melting point glass 5. A principal face (upper face) of the lid 4 may have a wavelength plate adhered thereto or may have a coated film applied thereto as occasion demands so that the wavelength of light (laser light) emitted from a light emitting element 6 may pass through the lid 4 most efficiently.

The light emitting element 6 is mounted on the element mount portion 2. The light emitting element 6 is formed from, for example, a semiconductor laser and is mounted in a vertical direction on one side face of the element mount portion 2 such that the light emitting point of the laser light is directed upwardly in FIG. 1. The light emitting element 6 is sealed with a cap (sealing member) 7 made of a metal material such as, for example, copper or aluminum. The cap 7 has a hollow structure of a substantially quadrangular shape as viewed in plan wherein a portion thereof in the direction of the center axis thereof (in the upward and downward direction in FIG. 1) is open while the opposite portion is closed up. The cap 7 has a flange portion 8 provided integrally on an edge portion of the opening. The cap 7 is securely attached to the lower face (first face) 9 side of the package body 1 in such a state that it surrounds the light emitting element 6 and the element mount portion 2. In this attached state, the flange portion 8 of the cap 7 is bonded in a closely contacting state to the lower face 9 of the package body 1, for example, by seam welding or the like over an overall periphery of the opening of the cap.

Meanwhile, a light receiving element 11 is carried on an upper face (second face) 10 of the package body 1. The upper face 10 of the package body 1 serves as a reference plane, for example, when the package body 1 is to be mounted on a base board (not shown) of an optical pickup. In particular, where the light emitting and receiving integrated device is to be mounted on a base board of an optical pickup, it is attached in a state wherein the upper face 10 of the package body 1 is abutted with the base board. The light receiving element 11 is mounted immediately on the upper face 10 of the package body 1 which serves as a reference plane upon apparatus attachment. The light receiving element 11 is formed, for example, from a photodiode and is mounted horizontally on the package body 1 in such a form that the light receiving face thereof is directed in the direction (upward direction in FIG. 1) same as the emitting direction of laser light from the light emitting element 6.

Further, a lead pin 12 is attached to the package body 1 in such a state that it extends through the package body 1 in the thicknesswise direction. The lead pin 12 is securely bonded to the package body 1 by means of low-melting point glass 13. The lead pin 12 is disposed such that one end side thereof projects to the lower face 9 side of the package body 1 within the sealed region by the cap 7 and the other end side thereof projects to the upper face 10 side of the package body 1.

The lead pin 12 is provided in order to supply power to the light emitting element 6 and the light receiving element 11 therethrough. If the lead pin 12 is provided in order to supply power, for example, to the light emitting element 6, then it is connected to the light emitting element 6 by a bonding wire not shown such as a very thin gold wire. However, if the lead pin 12 is provided in order to supply power to the light receiving element 11, then it is connected to the light receiving element 11 by a bonding wire not shown. To this end, a flattened wire connecting face (not shown) is formed at an end portion of the lead pin 12, which is an object of wire boding, by presswork.

A spacer member 14 is mounted on the upper face 10 of the package body 1. The spacer member 14 is a hollow member formed from, for example, a molded article of a resin material and is securely joined to the package body 1, for example, using a bonding agent. The spacer member 14 is provided in such a state that it surrounds the lid 4, light receiving element 11 and lead pin 12 described hereinabove. Further, the spacer member 14 has an opening 15 formed at a ceiling portion thereof. The opening 15 is provided to allow light emitted from the light emitting element 6 to emerge from the spacer member 14 therethrough or accept returning light of the emerging light therethrough.

An optical part 16 made of a glass or resin material and having a light transmission property is mounted on an upper face of the spacer member 14. Where the optical part 16 is formed from a resin material, preferably a liquid crystal polymer superior in heat resisting property is used. The optical part 16 is attached to the spacer member 14, for example, by a bonding agent in such a state that it closes up the opening 15. The spacer member 14 is provided in order to assure a predetermined distance between the light receiving element 11 and the optical part 16, that is, a distance necessary for the returning light to be polarized by the optical part 16 and received by the light receiving element 11. A grating portion not shown for splitting light emitted from the light emitting element 6 into three light beams is formed on an upper face of the optical part 16. Further, a hologram portion not shown for polarizing returning light of light emitted from the light emitting element 6 such as, for example, light reflected by the surface of an optical disk, toward the light receiving face of the light receiving element 11 is formed on the lower face of the optical part 16.

In the light emitting and receiving integrated device having the configuration described above, laser light emitted from the light emitting element 6 is led out to the upper face 10 side of the package body 1 through the light transmission portion 3 formed in the package body 1 and the lid 4 which closes up the light transmission portion 3 and then comes to the optical part 16 through the opening 15 of the spacer member 14. Then, the laser light is split into and emerges as three light beams, that is, a main beam and two sub beams, by the grating portion formed on the upper face of the optical part 16. Returning light of the light beams emerging in this manner is polarized by the hologram section formed on the lower face of the optical part 16 and then received by the receiving face of the light receiving element 11.

Now, a method of producing the light emitting and receiving integrated device having the configuration described above is described. First, on a package body 1 to which a lid 4 and a lead pin 12 are secured already by means of low-melting point glass 5 and 13, a light emitting element 6 is mounted with reference to the upper face 10 of the package body 1. The mounting position of the light emitting element 6 is adjusted such that, for example, an image processing system wherein, while light is irradiated from a lamp from above the package body 1, an image of the package body 1 or the light emitting element 6 is fetched and processed by a camera such as a CCD camera is utilized such that the focus of the camera is first adjusted on the upper face 10 so that the upper face 10 of the package body 1 may be positioned at a zero reference position. And then the focal position of the camera is displaced by a predetermined distance from the adjusted focal position until the light emitting point of the light emitting element 6 is positioned at the displaced focal position. After the mounting position is adjusted in this manner, a bonding agent or the like is used to secure the light emitting element 6 to the element mount portion 2. Thereafter, the light emitting element 6 and the lead pin 12 are connected to each other by a bonding wire. Incidentally, if the element mount portion 2 is a separate member from the package body 1, then before the light emitting element 6 is mounted, the element mount portion 2 is securely joined to the package body 1.

Then, a cap 7 is attached to the lower face 9 of the package body 1 to seal the light emitting element 6 into an airtight state by means of the cap 7. The fixation of the cap 7 to the package body 1 is performed using seam welding or the like. Then, after a light receiving element 11 is mounted (fixed) on the upper face 10 of the package body 1 by die bonding, a bonding wire process is performed for the light receiving element 11. Then, a spacer member 14 is mounted on the upper face 10 of the package body 1 using a bonding agent or the like, and then an optical part 16 is attached to the upper face of the spacer member 14 using a bonding agent or the like. Thereupon, in a state wherein the optical part 16 is temporarily secured to the spacer member 14, the light emitting element 6 is energized to emit light, and returning light of the emitted light is received by means of the light receiving element 11 while the mounted position of the optical part 16 is adjusted. After the adjustment, the optical part 16 is secured finally to the spacer member 14.

In the light emitting and receiving integrated device obtained by such a procedure as described above, since it is necessary to seal only the light emitting element 6 from between the light emitting element 6 and the light receiving element 11 by means of the cap 7, the sealing region (sealing space) by the cap 7 can be reduced significantly when compared with that of the conventional apparatus. Consequently, the cap 7 can be reduced in size to reduce the mounting area of the package body 1 and the cap 7 when compared with that in the conventional apparatus. Therefore, the light emitting element 6 can be sealed with a high degree of air-tightness. Further, since the light transmission portion 3 of the package body 1 is closed up with the lid 4 by attaching the lid 4 to the package body 1 by means of the low-melting point glass 5, the air-tightness in the cap 7 can be maintained at a high level. Further, since the necessity to mount the optical part 16 on the cap 7 is eliminated, the dimensional tolerance when the cap 7 is worked (for example, drawing) can be moderated significantly.

Further, in the conventional light emitting and receiving integrated devices, since an opening is formed on a cap and is closed up with an optical part, if, for example, an optical part of a resin material whose cost is lower than that of a glass material is adopted, then the air-tightness of the cap is deteriorated by the moisture absorption of the optical part itself. However, with the light emitting and receiving integrated device according to the present embodiment, there is no necessity to provide an opening in the cap 7, and besides the optical part 16 does not have any influence on the air-tightness of the cap 7. Therefore, even where an optical part of a resin material is adopted as the optical part 16, a high degree of air-tightness can be implemented.

Further, in the light emitting and receiving integrated device according to the present embodiment, since the upper face 10 of the package body 1 is determined as a reference plane upon apparatus mounting and the light receiving element 11 is mounted on the face same as the reference plane, in a state wherein the light emitting and receiving integrated device is mounted with reference to the upper face 10 of the package body 1, the light receiving face (upper face) of the light receiving element 11 can be positioned with a high degree of accuracy with reference to the upper face 10 of the package body 1. Further, by adjusting the position of the light emitting point of the light emitting element 6 with reference to the upper face 10 of the package body 1, the light emitting point of the light emitting element 6 and the light receiving face of the light receiving element 11 can be positioned with a high degree of accuracy with reference to the common reference plane provided by the upper face 10 of the package body 1. Incidentally, in the conventional light emitting and receiving integrated device, the dimension between the reference plane (upper face) of the package body and the mounting face of the light receiving element (upper face of the element mounting portion) has an error by working of the element mounting section. This error in dimension appears as positional displacement of the light emitting element and the light receiving face of the light receiving element when the light emitting and receiving integrated device is mounted with reference to the upper face of the package body.

Further, in the light emitting and receiving integrated device according to the present embodiment, heat generated upon driving of the light emitting element 6 can be transmitted from the element mount portion 2 to the package body 1 so that it can be radiated to the outside efficiently. Further, since the cap 7 made of a metal can be disposed nearer to the light emitting element 6 than that in the conventional apparatus, heat generated from the light emitting element 6 can be transmitted to the cap 7 and can be radiated to the outside efficiently. Accordingly, a high heat radiating property can be provided.

Further, in the light emitting and receiving integrated device according to the present embodiment, since the spacer member 14 made of a resin material is mounted on the upper face 10 of the package body 1 and the optical part 16 is mounted on the spacer member 14, heat of the package body 1 is less likely to be transmitted to the optical part 16 by a heat insulating action of the spacer member 14. Accordingly, where a printed wiring board (not shown) is to be soldered to the package body 1 in the configuration in which the optical part 16 made of a resin material is adopted, transmission of heat by the soldering is suppressed by the spacer member 14, and thermal damage (deformation or the like) of the optical part 16 can be prevented.

The present invention can be implemented also as an optical disk apparatus wherein the light emitting and receiving integrated device of the configuration described above is adopted as a part for an optical pickup.

It should be understood by those skilled in the art that various modifications, combinations, sub-combinations and alternations may occur depending on design requirements and other factors insofar as they are within the scope of the appended claims or the equivalents thereof.

What is claimed is:

1. A light emitting and receiving integrated device, comprising:
a package body;
a light emitting element mounted on a first face side of said package body;
a light receiving element mounted on a second face side of said package body remote from said first face; and
a sealing member for sealing said light emitting element on said first face side of said package body.

2. The light emitting and receiving integrated device according to claim 1,
wherein said second face of said package body is used as a reference plane upon apparatus mounting of said package body, and
said light receiving element is carried on a face same as the reference plane.

3. The light emitting and receiving integrated device according to claim 1,
wherein a spacer member made of a resin material is mounted on said second face of said package body, and
an optical part is mounted on said spacer member.

4. The light emitting and receiving integrated device according to claim 1,
wherein said package body has a light transmission portion formed thereon such that light emitted from said light emitting element is led out to said second face side of said package body through said light transmission portion.

5. An optical disk apparatus, comprising:
an optical pickup including a light emitting and receiving integrated device;
said light emitting and receiving integrated device including
a package body,
a light emitting element mounted on a first face side of said package body,
a light receiving element mounted on a second face side of said package body remote from said first face, and
a sealing member for sealing said light emitting element on said first face side of said package body.
